(19) United States
(12) Patent Application Publication
(10) Pub. No.: US 2006/0002550 A1
(43) Pub. Date: Jan. 5, 2006

(54) Method and system for generation of cryptographic keys and the like

(75) Inventors: Matthew J. Campagna, Ridgefield, CT (US); Conor Meagher, Moncton (CA)

Correspondence Address: Pitney Bowes Inc.;Intellectual Property and Technology Law Dept., 35 Waterview Drive, P.O. Box 3000, Shelton, CT, 06484, US

(73) Assignee: Pitney Bowes Incorporated, Stamford, CT (US)

(21) Appl. No.: 10/853,047

(22) Filed: May 25, 2004

(51) Int. Cl. H04L 9/00

(52) U.S. Cl. 380/46

(57) ABSTRACT

A method and system for generating cryptographic keys and similar secret cryptographic inputs that are hard to guess. A seed is input from an entropy source, and an initial composite state is generated as a function of the seed, the initial state comprising a plurality of components. The components include at least an initial state component and a state-update component. When a request to generate a cryptographic key is received all components of a current state, where the current state is initially the initial state, are mixed to generate an output string and a next state and the current state is set to the next state. The requested cryptographic key is generated from the string; and output. These steps can be repeated to generate successive output strings with assurance of forward and backward secrecy.

### BACKGROUND OF THE INVENTION

The subject invention relates to a method and system for generating secret inputs, such as keys, to a cryptographic system. More particularly it relates to a method and system for generating inputs, typically in the form of binary strings, which are “hard” to guess. By “hard” herein is meant that given realistic computational resources a secret input cannot be discovered, given less than all the inputs used to create the secret input, in less than exponential time. Still more particularly it relates to a method and system for generating keys for digital postage meters which rely on cryptographic techniques to create secure, digitally printed postal indicia.

Encryption, Digital Signature algorithms, and Key Agreement Protocols and similar cryptographic systems rely on two basic assumptions to keep information secure:

1. The algorithms used are sound, and cannot be attacked directly. That means you cannot derive information about inputs to the algorithm that you did not know before hand; nor can you derive the output of the algorithm unless you know all the inputs.

2. Any secret input of the algorithm is hard to guess. Typically secret inputs are inputs such as: a secret key, a random value used for “blocking” (i.e. used to hide other information), or the private portion of a public key pair. (As used herein the terms “key” or “cryptographic key” are meant to include any string of random bits for cryptographic applications, such as a secret input or a hard to guess value from which a secret input is derived; e.g. a hard to guess value from which a public/private key pair is derived; as well as strings used in applications where the random bits become known and still strong security of the DRBG is required.)

Methods and systems such as that of the present invention (hereinafter sometimes “Deterministic Random Bit Generators” or “DRBG's”) are used to satisfy this second assumption, and are used throughout standard cryptographic protocols and operations such as: SSL/TLS Secure Sockets Layer Protocol, DSA—Digital Signature Algorithm, Diffie-Hellman Key Exchanges, RSA Encryption and Signing Algorithms, etc. DRBG's provide the basic hard to guess inputs to such cryptographic operations. Typically DRBG's include an initialization routine to generate an initial state variable, a generation routine to generate a requested secret input, and can include a reseed routine to recover security properties in the event the DRBG is compromised.

The current family of ANSI (American National Standards Institute) approved DRBG's (based on DES and SHA1 standards) are aging in the sense of being antiquated by newer algorithms and stronger security requirements. In fact DES is broken in the sense that a sub-exponential algorithm to break it is known.

Current security specifications for AES and ECC provide security that require on the order of 2²⁵⁶ computational operations to break an algorithm. However, the present inventors are not aware of DRBG's that adequately provide that level of security; which reduces the security of algorithms using DRBG's because the second assumption discussed above is not fully satisfied at the strength of the algorithm. That is, while it may require 2²⁵⁶ operations work to break the algorithm, it may only require 2⁵⁶ operations to discover the secret key used; which would then reduce overall security to 2⁵⁶ operations (in most cases).

It is also advantageous to provide a DRBG having a consistent, or “flat”, forward secrecy profile and backward secrecy, against all known state assumptions. Backward secrecy is the property that even with knowledge of the current state of the DRBG it remains hard to determine previous components of the state. A flat forward secrecy profile is the property that even with any (less than complete) knowledge of the current state it remains hard to predict future output of the DRBG, or future unknown components of the state.

Thus it is an object of the subject invention to provide a method and system for generating secret inputs which provides increased levels of security for cryptographic systems, and which has the properties of a flat forward secrecy profile and backwards secrecy.

### BRIEF SUMMARY OF THE INVENTION

The above object is achieved and the disadvantages of the prior art are overcome in accordance with the subject invention by a method, and system operating in accordance with the method, for generating a random bit value that can be used, for example, as a cryptographic key which is hard to guess, by inputting a seed from an entropy source; generating an initial composite state as a function of the seed, the initial state comprising a plurality of components, the components including at least an initial state component and a state-update component; receiving a request to generate a random bit value; mixing all components of a current state, where the current state is initially the initial state, to generate an output string and a next state; then setting the current state to the next state, whereby the mixing of all components and setting the current state to a next state can be repeated to generate successive output strings with assurance of forward and backward secrecy; and deriving the requested random bit value from the at least one of the output strings.

As used herein “mixing” a set of values means generating an output as a function of all the values where the function has the property that it is hard (as “hard” is defined herein) to determine the output, or to recover the set of values from the output, with less than full knowledge of the set.

In accordance with one aspect of the subject invention the components are generated by mixing the seed with itself or with other information. The seed can be mixed using a codebook key definition function, a hash function, or a keyed hash function.

In accordance with another aspect of the subject invention the components are mixed using a codebook function, a hash function, or a keyed hash function.

A codebook key definition function “cb_kdf” is based on codebook encryption function cb, which is preferably a known function such as DES or AES. A codebook function is an encryption function of the form cb(<input>, <key>) that operates on a fixed length block of data <input> with a key,<key> by mixing it as well as introducing randomness (derived from <key>) into the output block. Suitable, known codebook functions are DES and AES. As used herein the term codebook key definition function means a function which has the form has the form cb_kdf(<output length>, <key>, <input1>, <input2>, . . . ) and compacts or expands a convenient function of <input1>, <input2>. . . , to generate an operand of appropriate length, then applies the encryption function cb to the operand, using <key> as the secret key, to generate an output of length <output length>.

In accordance with another aspect of the subject invention the output string is specified to be n bits in length and the components are mixed m times, each time generating a substring r bits in length, where m times r is greater than or equal to n and the output string is chosen to be n predetermined bits of a concatenation of the substrings.

In accordance with another aspect of the subject invention the initial state is generated using a codebook key definition function by: a) determining a seed s, the seed s having k bits of entropy; b) determining parameters CB_KEY_LENGTH and CB_WIDTH, each of the parameters being greater than or equal to k; c) determining application constants KEY_CONST1, KEY_CONST2, KEY_CONST3, C_CONST, and V_CONST; d) setting a codebook key, kdk, equal to CB_KEY_LENGTH predetermined bits of the seed s; e) computing a component K1 as a codebook key derivation function: cb_kdf(CB_KEY_LENGTH, kdk, s, KEY_CONST1); f) computing a component K2 as a codebook key derivation function: cb_kdf(CB_KEY_LENGTH, kdk, s, KEY_CONST2); g) computing a component K3 as a codebook key derivation function: cb_kdf(CB_KEY_LENGTH, kdk, s, KEY_CONST3); h) computing a component V₀ as a codebook key derivation function: cb_kdf(CB_KEY_LENGTH, kdk, s, V_CONST); i) computing a component C as a codebook key derivation function: cb_kdf(CB_KEY_LENGTH, kdk, s, C_CONST); j) setting an index component i equal to 1; and k) outputting an initial state S₀ comprising the components:V₀, i, C, K1, K2, and K3.

In accordance with another aspect of the subject invention all components of a current state Sⱼ (state Sⱼ including components V₀, i, C, K1, K2, and K3) are mixed to generate an output string and a next state Sⱼ₊₁ by: a) determining the state Sⱼ; b) determining a length n for the output string, and a rate r; c) setting an integer value m equal to the smallest integer greater than length n divided by rate r, where r is an integer greater than 0 and less than or equal to the length of component C; d) setting a variable V equal to the component Vⱼ; e) setting an index q equal to 1; f) computing a variable M as a codebook function: M=cb(VxorC, K1), where “xor” represents an exclusive or operation; g) determining auxiliary data dt (which is preferably date and time); h) computing a variable I as an auxiliary mixing function af having at least the operands dt, i, and M; i) computing a variable W as a codebook function: W=cb(VxorI, K2); j) computing a variable V as a codebook function: V=cb(VxorM, K3); k) setting a variable R_{q} equal to r predetermined bits of the variable W; l) setting the component i equal to i+1, and the index q equal to q+1; m) if the index q is not equal to m+1, returning to f; otherwise n) setting a next component Vⱼ₊₁ equal to the variable V; o) computing the output string as n predetermined bits of a concatenation of variables R_{q}, where q equals 1 to m; whereby the next state Sⱼ₊₁ is determined as including (Vⱼ₊₁, i, C, K1, K2, K3).

In accordance with still another aspect of the subject invention the initial state is generated using a hash function by: a) determining a seed s, the seed s having 2*k bits of entropy; b) computing a component V₀ as hash function: hash(s); c) computing a component C as hash function: hash(s|V₀); d) setting an index component i equal to 1; and e) outputting an initial state S₀ comprising the components: V₀, i, C.

In accordance with still another aspect of the subject invention all components of a current state Sj (state Sⱼ including components Vⱼ, i, C) are mixed using a hash function by: a) determining the state Sⱼ; b) determining a length n for the output string, and a rate r and a parameter HASH_DIGESTSIZE; c) setting an integer value m equal to the smallest integer greater than length n divided by rate r, where r is an integer greater than 0 and less than or equal to HASH_DIGESTSIZE+1; d) computing a variable V as a hash function having at least operands C and Vⱼ; e) setting an integer value m equal to the smallest integer greater than length n divided by rate r, where r is an integer greater than 0 and less than or equal to the length of component C; f) setting an index q equal to 1; g) computing a variable x as a hash function: x=hash(V); h) setting a variable w_{q} equal to r predetermined bits of the variable x; i) computing the variable V as a function: V=V+1 (mod 2^{HASH}^{_{—}}^{DIGESTSIZE}); j) setting the index q equal to q+1; k) if the index q is not equal to m+1, returning to substep g; otherwise l) computing the output string as n predetermined bits of a concatenation of variables w_{q}, where q equals 1 to m; and m) computing a next component Vⱼ₊₁ as a hash function: Vⱼ₊₁=hash(V+yⱼ+i(mod 2^{HASH}^{_{—}}^{DIGESTSIZE})); whereby the next state Sⱼ₊₁ is determined as including (Vⱼ₊₁, i, C).

In accordance with still another aspect of the subject invention the initial state is generated using a keyed hash function by: a) determining seed s1 and s2, the seeds s1 and s2 having 2*k bits of entropy; b) computing a component V₀ as hash function: hash(s1); c) computing a component key K as hash function: hash(s2|V₀); d) computing a component C as keyed hash function: khash(V₀, K); d) setting an index component i equal to 1; and e) outputting an initial state S₀ comprising the components: V₀, i, C, K.

In accordance with still another aspect of the subject invention all components of a current state Sj (state Sⱼ including components Vⱼ, i, C, K) are mixed using a keyed hash function to generate an output string and a next state Sⱼ₊₁ by: a) determining the state Sⱼ; b) determining a length n for the output string, and a rate r and a parameter HASH_DIGESTSIZE; c) setting an integer value m equal to the smallest integer greater than length n divided by rate r, where r is an integer greater than 0 and less than or equal to HASH_DIGESTSIZE+1; d) computing a variable V as a keyed hash function having at least operands C and Vⱼ, and key K; e) setting an index q equal to 1; f) setting an integer value m equal to the smallest integer greater than length n divided by rate r, where r is an integer greater than 0 and less than or equal to the length of component C; g) computing a variable x as a keyed hash function: x=khash(V, K); h) setting a variable w_{q} equal to r predetermined bits of the variable x; i) compute the variable V as a function: V=V+1(mod 2^{HASH}^{_{—}}^{DIGESTSIZE}) j) setting the index q equal to q+1; k) if the index q is not equal to m+1, returning to substep g; otherwise l) computing the output string as n predetermined bits of a concatenation of variables w_{q}, where q equals 1 to m; and m) computing a next component Vⱼ₊₁ as a hash function: Vⱼ₊₁=hash(V+yⱼ+i(mod 2^{HASH}^{_{—}}^{DIGESTSIZE})); whereby the next state Sⱼ₊₁ is determined as including (Vⱼ₊₁, i, C, K).

Other objects and advantages of the subject invention will be apparent to those skilled in the art from consideration of the detailed description set forth below and the attached drawings.

### BRIEF DESCRIPTION OF THE DRAWINGS

FIG. 1 shows a schematic block diagram of an encryption system comprising a DRBG in accordance with the subject invention.

FIG. 2 shows a generalized flow diagram of a method for generating a cryptographic key.

FIGS. 3a, 3b, and 3c show a flow diagram of a codebook function based method for generating a cryptographic key.

FIGS. 4a, 4b , and 4c show a flow diagram of a hash function based method for generating a cryptographic key.

FIGS. 5a, 5b, and c show a flow diagram of a keyed hash function based method for generating a cryptographic key.

### DETAILED DESCRIPTION OF PREFERRED EMBODIMENTS OF THE INVENTION

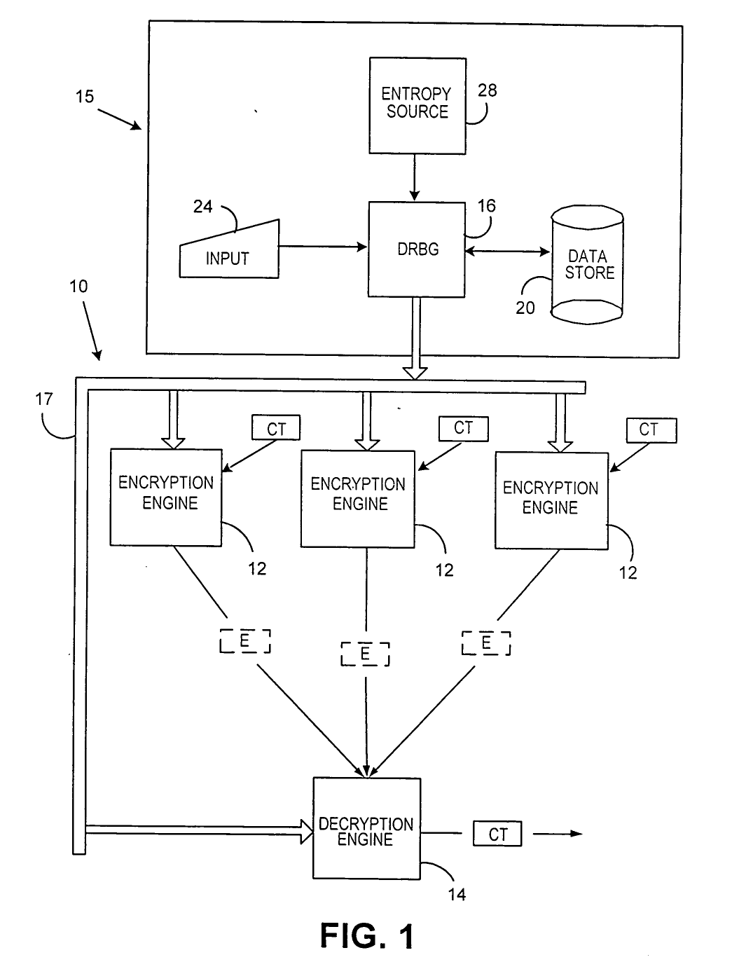

In FIG. 1 system 10 is a generalized encryption system. Encryption engines 12 receive clear text messages CT and combine them with a secret input (hereinafter sometimes a “key” or “cryptographic key” or “encryption key”) in accordance with an encryption standard such as the symmetric key standard, DES; or the public key standard, RSA to generate encryptions E. The encryptions are the then sent to decryption engine 14 in any convenient manner where they are decrypted using the appropriate decryption key (which can be the same as the encryption key or may be part of an encryption/decryption key pair) to recover messages CT for further distribution. (Only one engine 14 is shown for simplicity of illustration.) Without knowledge of the keys used it is hard to recover messages CT (or at least more costly than the value of the information obtained would justify). System 10 can also carry out other cryptographic operations such as digital signing of messages in a substantially similar manner. In a preferred embodiment of the subject invention encryption engines 12 are digital postage meters such as the FIPS meter marketed by the assignee of the present patent application which use cryptographic techniques to authenticate digitally printed postal indicia and decryption engine 14 is incorporated in postal service mail handling systems to validate the indicia on mail pieces printed by the meters.

History shows, however, that in time any secret can be learned. System 10 therefore includes key generation system 15 for generating new keys from time to time as necessary. (The new keys must of course be distributed to engines 12 and 14 in a secure manner through secure communications link 17. This can be done in any convenient manner, details of which form no part of the subject invention.) System 15 includes DRBG 16, (which is typically implemented as an application run on a programmed data processing system) data store 20 for storing algorithms and constants used to generate keys, input 24 for input of various parameters used to specify the keys to be generated, and entropy source 28 for generating seed values used to initialize or reseed DRBG 16; as will be described further below.

Entropy source 28 is a conventional apparatus which generates random output values based on measurement of physical phenomena. Typically entropy sources are based on apparatus such as ring oscillators, pluralities of high speed clocks and the drift among them, radioactive decay, and keystroke timing. While such entropy generators do produce numbers which are random in the sense that they are practically unpredictable, or in the case of radioactive decay truly unpredictable, they have proven to be unsatisfactory for directly generating keys for two reasons: the output is not flat, i.e. all output values are not equally likely; and known entropy sources are too slow to generate the large number of keys needed for large cryptographic systems.

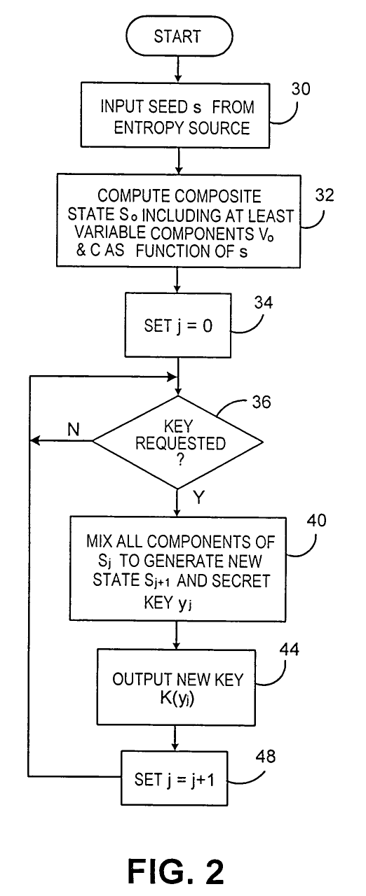

FIG. 2 shows a flow diagram of the general operation of DRBG 16 in accordance with the subject invention. In FIG. 2 values for parameters such as security parameters, user inputs, output bit string length, and purpose, (which will be described further below with respect to particular preferred embodiments of the subject invention) are considered to be predetermined.

At step 30 DRBG 16 calls for a seed s from entropy source 18. Preferably seed s will have an entropy value proportional to k (typically k or 2* k), where k is a predetermined parameter representative of a desired level of security.

As understood in the art entropy is a mathematical measure of the amount of information provided by observation of the state of a variable. Here the variable seed s is a binary bit string. It is easily shown that if entropy source 18 is flat, i.e. all values of s are equally likely, that observation of the state of s, where s is 2* k bits in length, provides 2* k bits of entropy. However since, in general, entropy sources are not flat, s typically must be more than 2* k bits in length to provide 2* k bits of entropy.

At step 32 DRBG 16 computes initial composite state S₀ which includes at least components V₀ and C. Preferably components V₀ and C are computed by mixing seed s, either with itself or with other information; which can include a second seed s' and predetermined constants.

At step 34 DRBG 16 sets j=0 and at step 36 waits for a request for a key to be generated. When a request is received, at step 40 DRBG 16 mixes all components of state Sⱼ, to generate a new state Sⱼ₊₁ and an output string yⱼ of predetermined length. At step 44 new key K(yⱼ) is output and, at step 48, j is set to j+1 and DRBG returns to step 36.

Those skilled in the art will recognize that K(yⱼ) can be simply yⱼ itself or can be a function of yⱼ, sometimes complicated; as where K(yⱼ) is actually an encryption/decryption (or public/private) key pair. Such derivations of K(yⱼ) are well known and details of them form no part of the subject invention. For simplicity of description K(yⱼ) will be assumed equal to yⱼ in the detailed description below.

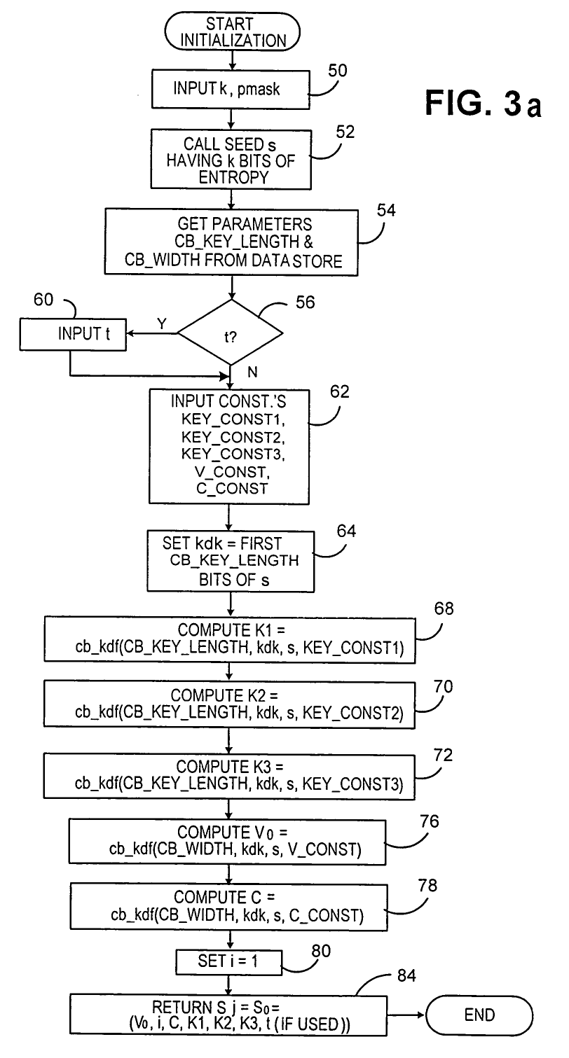

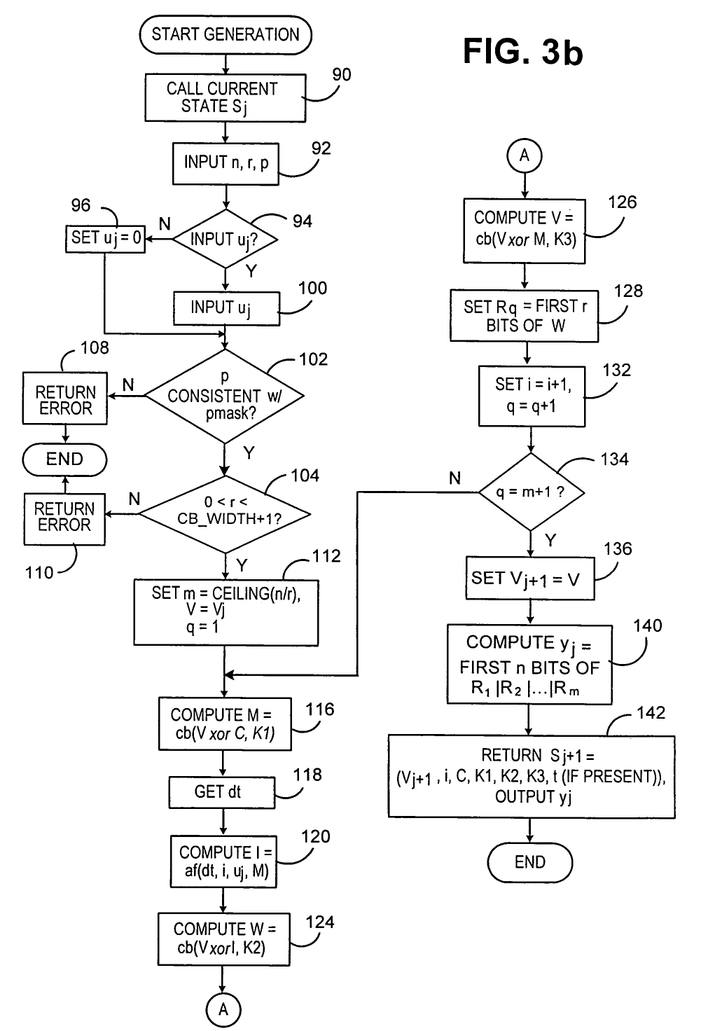

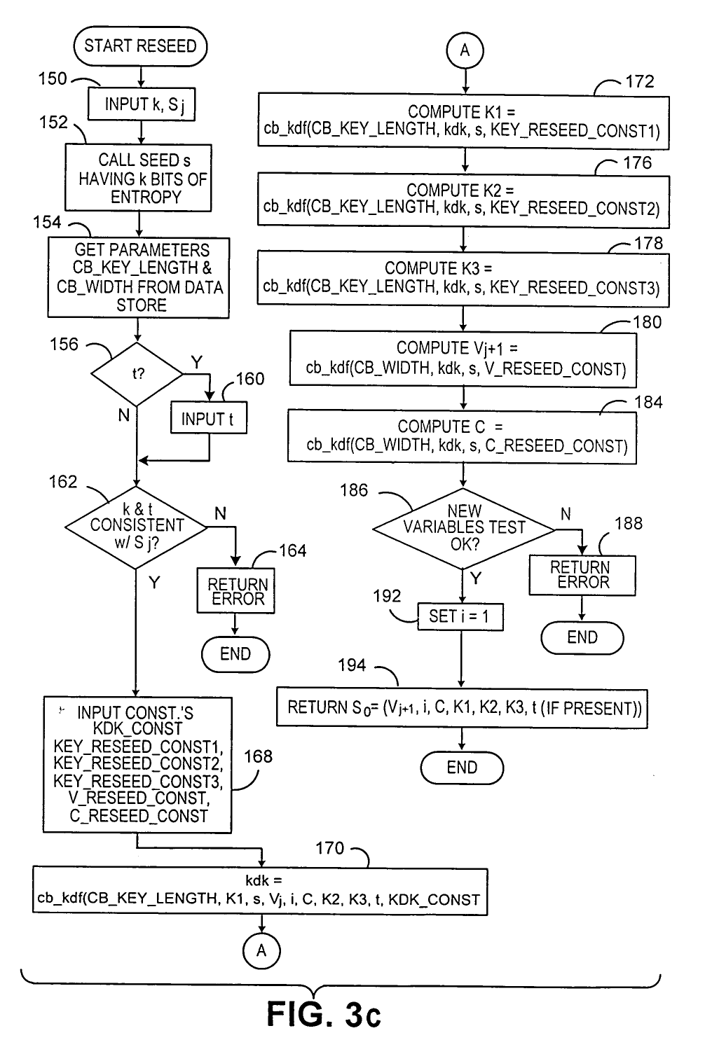

FIGS. 3a, 3b, and 3c show detailed flow diagrams of the operation of DRBG 16 in accordance with a preferred embodiment of the subject invention which uses a conventional codebook encryption function, “cb” to mix components of state Sⱼ.

In FIG. 3a, an initialization routine is shown, where at step 50, DRBG 16 inputs security parameter k, which defines the level of security required, and mask pmask, which defines the purpose for which secret inputs yⱼ are to be generated.

Advantageously, particular instances of DRBG's can be limited to particular purposes, such as, for example, for generation of random values that will become known, i.e. a signing application, or for generation of random values that will be kept secret, i.e. symmetric key encryption. During initialization DRBG 16 inputs pmask which is a bit mask that specifies the particular instance of DRBG 16 is enabled only to generate keys yⱼ for specified purposes. For example, in pmask:
Bit 0=private use
Bit 1=public use
Bit 2=Diffie-Hellman
Bit 3=RSA Signing
Bit 4=DSA Signing
. . . Other known cryptographic uses for secret inputs
   As will be described further below, when a call is made to DRBG 16 to generate a secret input it returns an error message unless the purpose of that call is consistent with pmask.

At step 52 DRBG 16 calls seed s from entropy source 28; seed s having at least k bits of entropy. At step 54 it inputs constants CB_KEY_LENGTH and CB_WIDTH (both greater than or equal to k) from data store 20 as determined by parameter k.

At steps 56 and 60 DRBG 16 inputs optional constant t, if used. At step 62 application constants KEY_CONST1, KEY_CONST2, KEY_CONST3, C_CONST, and V_CONST are input. Preferably these constants are varied to associate particular instantiations of the DRBG with different users or applications.

At step 64 codebook key kdk is set equal to the first CB_KEY_LENGTH bits of s. At step 68 the component K1 is computed as:
cb_kdf(CB_KEY_LENGTH, kdk, s, KEY_CONST1)
At steps 70, 72 76, and 78 components K2, K3, C, and V₀ are computed similarly; substituting KEY_CONST2, KEY_CONST3, C_CONST, and V_CONST for KEY_CONST1, respectively.

At step 80 index i is set equal to 1, and at step 84 initial state S₀=(V₀, C, i, K1, K2, K3, t(if used)) of compound state variable Sⱼ is returned and DRBG 16 exits.

FIG. 3b shows the operation of DRBG 16 in generating requested secret input yⱼ. At step 90 current state Sⱼ is called. At step 92 DRBG 16 inputs parameters n, r, and p; where n specifies the length of yⱼ, r specifies the rate at which yⱼ will be generated, as will described further below, and p specifies the purpose for which yⱼ will used.

At steps 94, 96, and 100 optional user input uⱼ is input. A default value of 0 is assumed if uⱼ is not supplied.

At step 102 p is tested for consistency with pmask to determine if the intended use is one which is permitted for DRBG 16, and at step 104 r is tested to determine if it is greater than 0 and less than CB_WIDTH+1. If either test is failed an appropriate error message is returned at steps 108 or 110 respectively, and DRBG 16 exits.

If both tests are passed, at step 112 m, the number of cycles needed to compute yⱼ at a rate of r bits a cycle, is computed as:
m=ceiling(n/r)(the smallest integer greater than or equal to n/r);
the variable V is set equal to Vⱼ and index q is set equal to 1.

Then at step 116 variable M is computed as:
M=cb(VxorC, K1);
where cb is the underlying codebook function described above with key K1 and “xor” represents an exclusive or operation.

At step 118 DRBG 16 gets auxiliary information dt, which is preferably date and time information and also preferably will vary for each cycle; and at step 120 computes variable I as:
I=af((dt, i, uⱼ M);
where function af is a predetermined mixing function which preferably has the form:
I=dt+uⱼ+i+M(mod 2^{drbg→width});
where “drbg→width” is the width of the underlying block on which the underlying codebook function is defined: e.g. for cb=DES−64 bits, cb=AES−128 bits, etc. In other embodiments of the subject invention function af can be a conventional hashing function.

Then at step 124 variable W is computed as:
W=cb(Vxorl, K2);
and then at step 126 variable V is computed as:
V=cb(VxorM, K3).
Where steps 124 and 126 are carried in substantially the same manner as step 116 described above.

At step 128 variable R_{q} is set equal to the first r bits of variable W, and at step 132 indices i and q are set equal to i+1 and q+1 respectively. Then at step 134 index q is tested to determine if it is equal to m+1. If so, DRBG 16 returns to step 116 to compute another cycle of R_{q}.

Otherwise, at step 136 Vⱼ₊₁ is set equal to V, and at step 140 secret input yⱼ is computed as:
yⱼ=the first n bits of R₁|R₂| . . . |Rₘ; where “|” represents concatenation.

At step 142 DRBG 16 returns next state Sⱼ₊₁ as:
Sⱼ₊₁=(Vⱼ₊₁, i, C, K1, K2, K3, t(if used));
outputs secret input yⱼ and exits.

In FIG. 3c a reseed routine is shown. It is known to use reseed routines to recover the property of forward secrecy for DRBG 16 when some or all of the constants KEY_CONST1, etc. become known. In the subject invention this is achieved in a novel manner by mixing the components of the current state Sⱼ with a new seed s and new constants to generate a reseeded composite state Sⱼ₊₁.

In FIG. 3c, at step 150, DRBG 16 inputs security parameter k, which defines the level of security required, and current state Sⱼ.

At step 152 DRBG 16 calls seed s from entropy source 28; seed s having at least k bits of entropy. At step 154 it inputs constants CB_KEY_LENGTH and CB_WIDTH (both greater than k) from data store 20 as determined by parameter k.

At steps 156 and 160 DRBG 16 inputs optional constant t, if used. At step 162 it determines if the input values for k and t are consistent with state Sⱼ. If not at step 164 it returns an appropriate error message and exits.

Otherwise, at step 168 application constants KDK_CONST, KEY_RESEED_CONST1, KEY_RESEED_CONST2, KEY_RESEED_CONST3, C_RESEED_CONST, and V_RESEED_CONST are input.

At step 170 codebook key kdk is computed as:
kdk=cb_{—}kdf(CB_KEY_LENGTH, K1, s, Vⱼ, i, C, K2, K3, t, KDK_CONST);
where cb_kdf is the function described above with respect to the initialization routine.

At step 172 the component K1 is computed as:
cb_kdf(CB_KEY_LENGTH, kdk, s, KEY_RESEED_CONST1)
At steps 176, 178, 180, and 184 components K2, K3, C, and Vⱼ₊₁ are computed similarly; substituting KEY_RESEED_CONST2, KEY_RESEED_CONST3, V_RESEED_CONST, and C_RESEED_CONST for KEY_RESEED_CONST1, respectively.

At step 186 the new values for K1, etc. re tested to determine if they are consistent with state Sⱼ, and if not an appropriate error message is returned at step 188 and DRBG 16 exits.

Otherwise, at step 192 index i is set equal to 1, and at step 194 reseeded state Sⱼ₊₁=(Vⱼ₊₁, C, i, K1, K2, K3, t(if used)) of compound state Sⱼ is returned and DRBG 16 exits.

In another embodiment of the subject invention the initialization routine of FIG. 3a and reseed routine of FIG. 3c can be modified to produce only a single key and the generation routine of FIG. 3b can be modified to use that key in place of keys K1, K2, and K3.

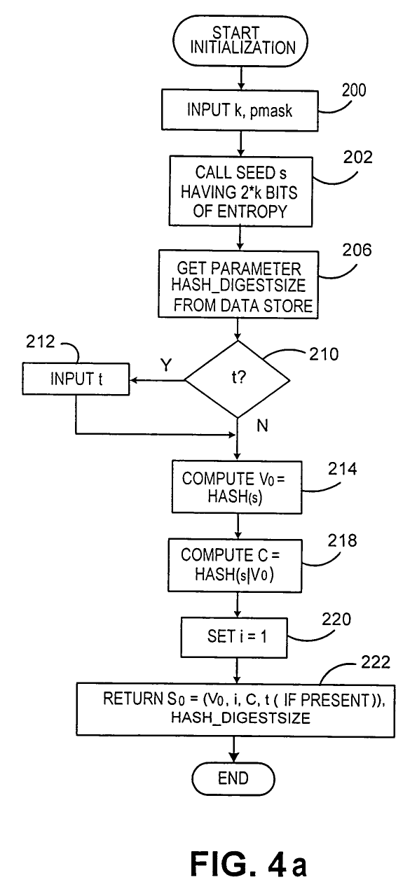

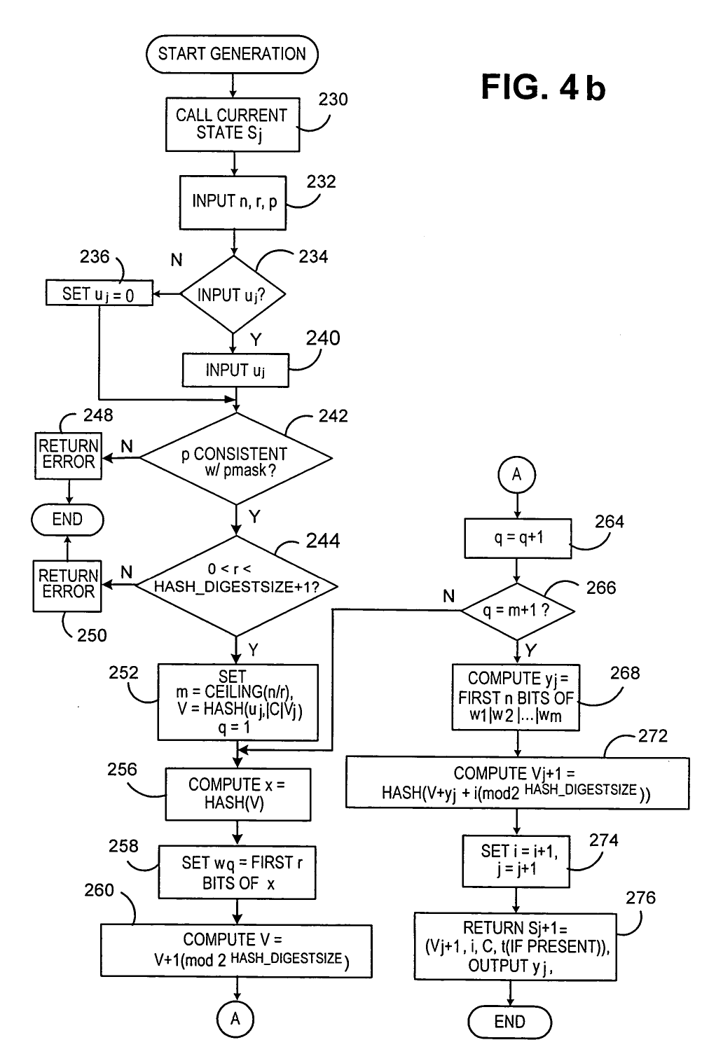

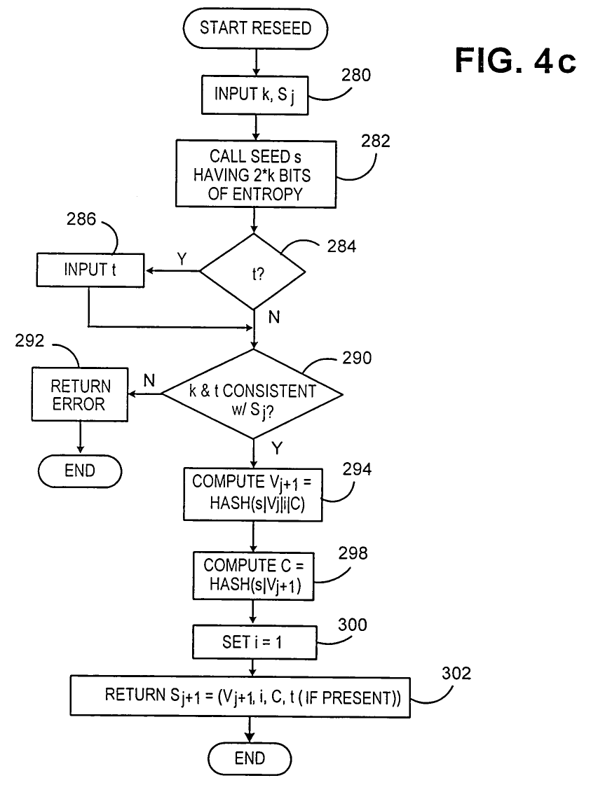

FIGS. 4a, 4b, and 4c show detailed flow diagrams of the operation of DRBG 16 in accordance with another preferred embodiment of the subject invention, which uses a conventional hashing function, “hash,” to mix components of state Sⱼ. (A hashing function operates on an input of arbitrary length to generate an output of predetermined size, the “digest length”, which is, with high probability, unique to the input. The recipient of a message and corresponding hash can thus be assured that the message was not altered after the hash was generated.) A suitable hash is SHA1.

In FIG. 4a, an initialization routine is shown, where at step 200, DRBG 16 inputs security parameter k, which defines the level of security required, and mask pmask, which defines the purpose for which secret inputs yⱼ are to be generated, as described above.

At step 202 DRBG 16 calls seed s from entropy source 28; seed s having at least 2* k bits of entropy. At step 206 it inputs constant HASH_DIGESTSIZE, defining the output size for the hash function (typically 2* k bits), from data store 20 as determined by parameter k.

At steps 210 and 212 DRBG 16 inputs optional constant t, if used.

At step 214 the component V₀ is computed as:
V₀=hash(s)

At step 218 the component C is computed as:
C=hash(s|V₀); where “|” again represents concatenation.

At step 220 index i is set equal to 1, and at step 222 initial state S₀=(V₀, C, t(if used)) of compound state variable Sⱼ is returned and DRBG 16 exits.

FIG. 4b shows the operation of DRBG 16 in generating requested secret input yⱼ in accordance with the present hash based embodiment. At step 230 current state Sⱼ is called. At step 232 DRBG 16 inputs parameters n, r, and p; where n specifies the length of yⱼ, r specifies the rate at which yⱼ will be generated, as will described further below, and p specifies the purpose for which yⱼ will used.

At steps 234, 236, and 240 optional user input uⱼ is input. A default value of 0 is assumed if uⱼ is not supplied.

At step 242 p is tested for consistency with pmask to determine if the intended use is one which is permitted for DRBG 16, and at step 244 r is tested to determine if it is greater than 0 and less than HASH_DIGESTSIZE+1. If either test is failed an appropriate error message is returned at steps 248 or 250 respectively, and DRBG 16 exits.

If both tests are passed, at step 252 m, the number of cycles needed to compute yⱼ at a rate of r bits a cycle, is computed as:
m=ceiling(n/r);
the variable V is computed as:
V=hash(uⱼ|C|Vⱼ); and
index q is set equal to 1.

Then at step 256 variable x is computed as:
x=hash(V);
and at step 258 variable w_{q} is set equal to the first r bits of x.

At step 260 variable V is computed as:
V=V+1(mod 2^{HASH}^{_{—}}^{DIGESTSIZE}).

At step 264 index q is set equal to q+1. Then at step 266 index q is tested to determine if it is equal to m+1. If so, DRBG 16 returns to step 116 to compute another cycle of w_{q}.

Otherwise, at step 268 secret input yⱼ is computed as:
yⱼ=the first n bits of w₁|w₂| . . . |wₘ;
and at step 272 Vⱼ₊₁ is computed as:
Vⱼ₊₁=hash(V+yⱼ₊₁+i(mod 2^{HASH}^{_{—}}^{DIGESTSIZE}))

At step 274 indices i and j are set equal to i+1 and j+1 respectively; and at step 276 DRBG 16 returns next state Sⱼ₊₁ as:
Sⱼ₊₁=(Vⱼ₊₁, i, C, t(if used)); and
outputs secret input yⱼ and exits.

In FIG. 4c a reseed routine is shown in accordance with the present embodiment. In FIG. 4c, at step 280, DRBG 16 inputs security parameter k, which defines the level of security required, and current state Sⱼ.

At step 282 DRBG 16 calls seed s from entropy source 28; seed s having at least 2* k bits of entropy.

At steps 284 and 286 DRBG 16 inputs optional constant t, if used. At step 290 it determines if the input values for k and t are consistent with state Sⱼ. If not at step 292 it returns an appropriate error message and exits.

At step 294 component Vⱼ₊₁ is computed as:
Vⱼ₊₁=hash(s|Vⱼ|i|C).

At step 298 component C is computed as:
C=hash(s|Vⱼ₊₁)

At step 300 index i is set equal to 1, and at step 302 reseeded state Sⱼ₊₁=(Vⱼ₊₁, i, C, t(if used)) of compound state variable Sⱼ is returned and DRBG 16 exits.

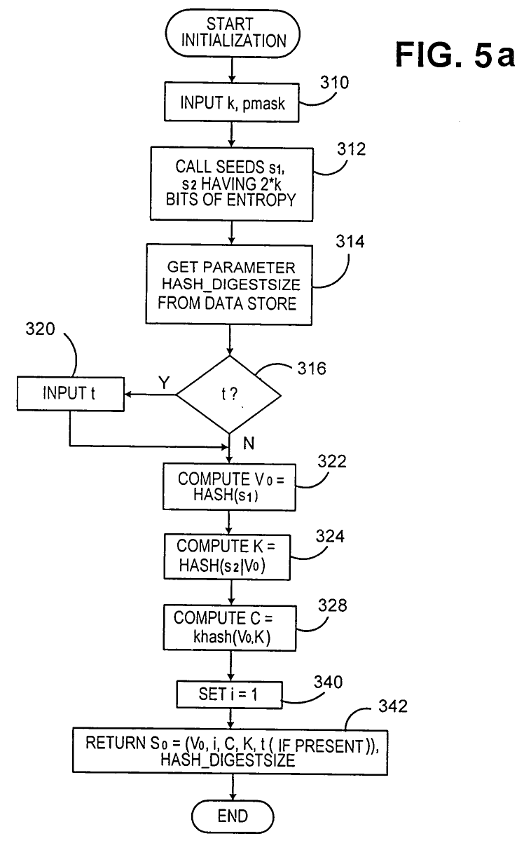

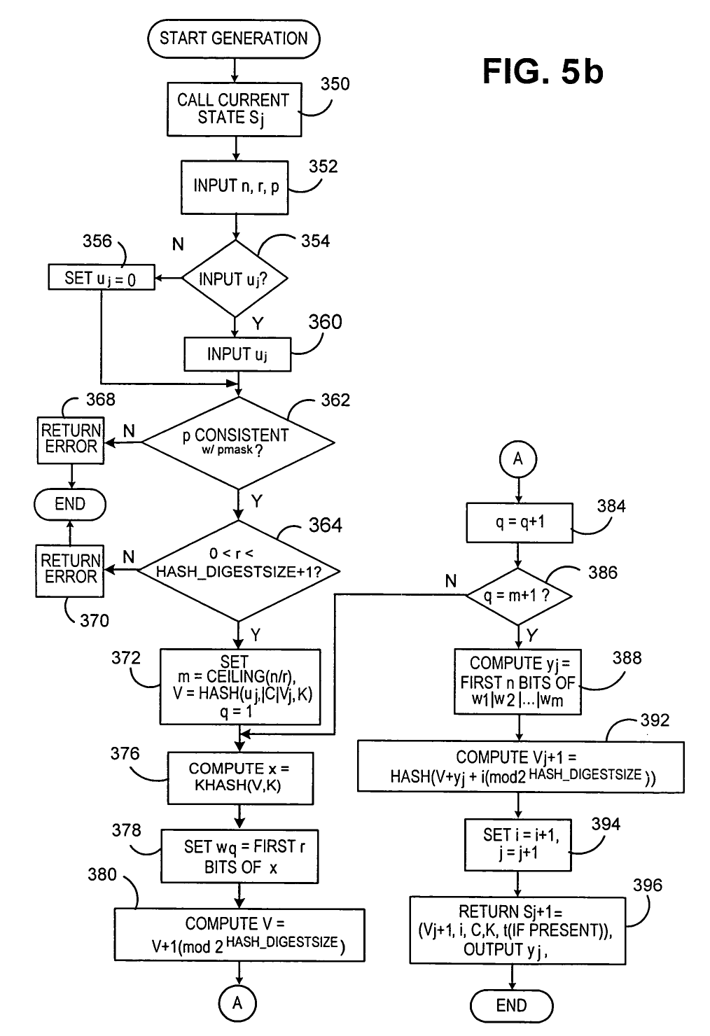

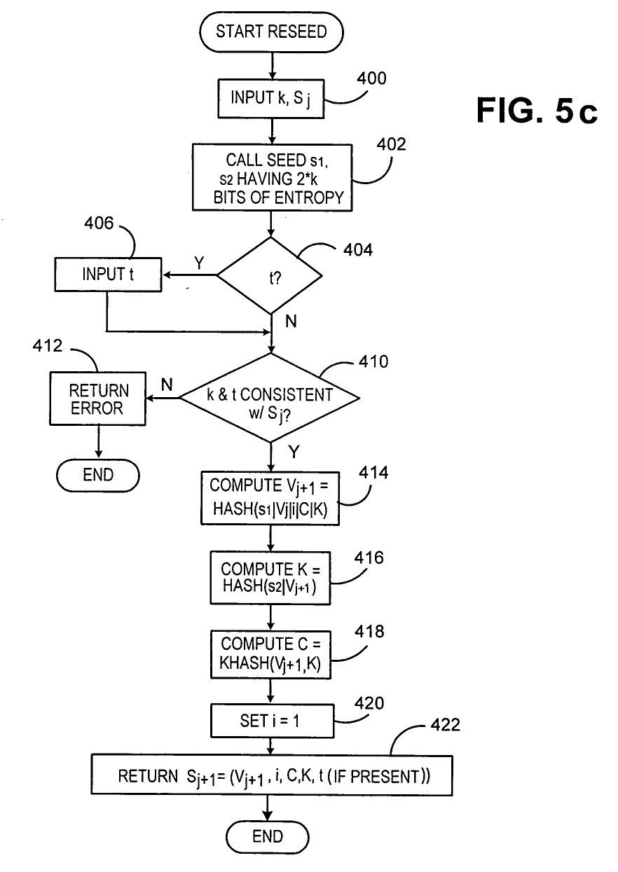

FIGS. 5a, 5b, and 5c show detailed flow diagrams of the operation of DRBG 16 in accordance with another preferred embodiment of the subject invention, which uses a conventional keyed hashing function, “khash,” to mix components of state Sⱼ. A keyed hashing function operates on an input of arbitrary length and a secret key to generate an output of predetermined size, the “digest length”, which is, with high probability, unique to the input and key. The recipient of a message and corresponding hash can thus be assured that the message was not altered after the hash was generated, and was produced by someone with the key. A suitable keyed hash is HMAC.

FIG. 5a shows the initialization of DRBG 16. In FIG. 5a, an initialization routine is shown, where at step 310, DRBG 16 inputs security parameter k, which defines the level of security required, and mask pmask, which defines the purpose for which secret inputs yⱼ are to be generated, as described above.

At step 312 DRBG 16 calls seeds s₁ and s₂ from entropy source 28; each having at least 2* k bits of entropy. At step 314 it inputs constant HASH_DIGESTSIZE, defining the output size for the hash and khash functions (typically 2* k bits), from data store 20 as determined by parameter k.

At steps 316 and 320 DRBG 16 inputs optional constant t, if used.

At step 322 the component V₀ is computed as:
V₀=hash(s₁); using a conventional hashing function such as SHA1

At step 324 the component K is computed as:
K=hash(s₂|V₀).

At step 328 the component C is computed as:
C=khash(V₀, K)

At step 340 index i is set equal to 1, and at step 342 initial state S₀=(V₀, i, C, K, t(if used)) of compound state variable Sⱼ is returned and DRBG 16 exits.

FIG. 5b shows the operation of DRBG 16 in generating requested secret input yⱼ in accordance with the present keyed hash based embodiment. At step 350 current state Sⱼ is called. At step 352 DRBG 16 inputs parameters n, r, and p; where n specifies the length of yⱼ, r specifies the rate at which yⱼ will be generated, as will described further below, and p specifies the purpose for which yⱼ will used.

At steps 354, 356, and 360 optional user input uⱼ is input. A default value of 0 is assumed if uⱼ is not supplied.

At step 362 p is tested for consistency with pmask to determine if the intended use is one which is permitted for DRBG 16, and at step 364 r is tested to determine if it is greater than 0 and less than HASH_DIGESTSIZE+1. If either test is failed an appropriate error message is returned at steps 368 or 370 respectively, and DRBG 16 exits.

If both tests are passed, at step 372 m, the number of cycles needed to compute yⱼ at a rate of r bits a cycle, is computed as:
m=ceiling(n/r);
the variable V is computed as:
V=khash(uⱼ|C|Vⱼ, K); and
index q is set equal to 1.

Then at step 376 variable x is computed as:
x=khash(V, K);
and at step 378 variable w_{q} is set equal to the first r bits of x.

At step 380 variable V is computed as:
V=V+1(mod 2^{HASH}^{_{—}}^{DIGESTSIZE}).

At step 384 index q is set equal q+1. Then at step 386 index q is tested to determine if it is equal to m+1. If not, DRBG 16 returns to step 116 to compute another cycle of w_{q}.

Otherwise, at step 388 secret input yⱼ is computed as:
yⱼ=the first n bits of w₁ |w₂| . . . |wₘ;
and at step 392 Vⱼ₊₁ is computed as:
Vⱼ₊₁=hash(V+yⱼ+i(mod 2^{HASH}^{_{—}}^{DIGESTSIZE}))

At step 394 indices i and j are set equal to i+1 and j+1 respectively; and at step 396 DRBG 16 returns next state Sⱼ₊₁ as:
Sⱼ₊₁=(Vⱼ₊₁, i, C, K, t(if used)); and
outputs secret input yⱼ and exits.

In FIG. 5c a reseed routine is shown in accordance with the present embodiment. In FIG. 5c, at step 400, DRBG 16 inputs security parameter k, which defines the level of security required, and current state Sⱼ.

At step 402 DRBG 16 calls seeds s, and S₂ from entropy source 28; each having at least 2* k bits of entropy.

At steps 404 and 406 DRBG 16 inputs optional constant t, if used. At step 410 it determines if the input values for k and t are consistent with state Sⱼ. If not at step 412 it returns an appropriate error message and exits.

At step 414 component Vⱼ₊₁ is computed as:
Vⱼ₊₁=hash(s₁|Vⱼ|i|C|K).

At step 416 component K is computed as:
K=hash(s₂|Vⱼ₊₁).

At step 418 component C is computed as:
C=khash(Vⱼ₊₁, K)

At step 420 index i is set equal to 1, And at step 422 reseeded state Sⱼ₊₁=(Vⱼ₊₁, i, C, K t(if used)) of compound state Sⱼ is returned and DRBG 16 exits.

In other embodiments of the subject invention the operation of DRBG 16 in accordance with FIGS. 5a-5c can be expanded to allow for multiple keys by passing additional seeds into the initialization routine of FIG. 5a and the reseed routine of FIG. 5c.

The following Tables 1, 2 and 3 give pseudo-C source code listings for particular implementations of the preferred embodiments of FIGS. 3a-3c; 4a-4c; and 5a-5c respectively. Note that some functions are not fully defined in these listings. However those skilled in the art will be able to implement the code given in any convenient manner without further specification.

TABLE 1

| | | |
|---|---|---|
| #define | SUCCESS | 0 |
| #define | ERROR | 0xFFFFFFFF |
| #define | MIN_ENTROPY_RATE | 8 |
| #define | MAX_ENTROPY | 512 |
| #define | MAX_SEED_LENGTH | MAX_ENTROPY* |
| | | MIN_ENTROPY_RATE |

typedef struct _cb_drbg{

int k;
int klength;
int width;
byte *V;
byte *i
byte *C;
byte *K;
byte *t;

}cb_drbg;
int aes_ecb(byte *out, byte *in, byte *key, int keylength, int cbwidth);
int aes_kdf(byte *out, int outlen, byte *key, int keylength, byte *input,
int inlength);
int entropy(byte *out, int *outlen, int k);
int validate_purpose(byte *t1, byte *t2);
int validate_new_drbg(cb_drbg *new, cb_drbg *old);
int initialize(cb_drbg *drbg, int k, byte *t)
{

byte seed[MAX_SEED_LENGTH];
int slength = MAX_SEED_LENGTH;
if((k!=128)&&(k!=192)&&(k!=256)) { return ERROR; }
drbg->width = drbg->klength = k;
if(entropy(seed, &slength, 2*k)) { return ERROR; }
if(validate_purpose(t, NULL)) {return ERROR; }
drbg->t = t;
drbg->i = 1;
if(aes_kdf(drbg->K,drbg->klength,seed,k,seed|“KEY”, slength+3))
{ return ERROR; }
if(aes_kdf(drbg->V,drbg->width,seed,k,seed|“STATE”,slength+5))
{ return ERROR; }
if(aes_kdf(drbg->C,drbg->width,seed,k,seed|“UPDATE”,
slength+6))
{ return ERROR; }
return SUCCESS;

}
int reseed(cb_drbg *drbg, int k, byte *t)
{

byte seed[MAX_SEED_LENGTH], key[MAX_ENTROPY];
int slength = MAX_SEED_LENGTH;
cb_drbg olddrbg;
olddrbg = drbg;
if(k!=drbg->k) { return ERROR;
}
if(validate_purpose(drbg->t, t)) { return ERROR;
}
if(entropy(seed, &slength, 2*k)) { return ERROR;
}
if(aes_kdf(key,k,seed,k,s|drbg->V|drbg->C|drbg->K,slength+drbg->

width*2+drbg->klength))

{ return ERROR;
}

if(aes_kdf(drbg->K,drbg->klength,key,k,seed|“KEY”,slength+3)
{ return ERROR;
}
if(aes_kdf(drbg->V,drbg->width,key,k,seed|“STATE”,slength+5))
{ return ERROR;
}
if(aes_kdf(drbg->C,drbg->width,key,k,seed|“UPDATE”,slength+6))
{ return ERROR;
}
drbg->i = 1; drbg->t = t;
if(validate_new_drbg(drbg, olddrbg)) { return ERROR;
}
destroy(oldrbg);
return SUCCESS;

}
int generate(byte *output, int length, cb_drbg *drbg, byte *user, int
ulength, int r,
byte *p)
{

int l, m;
byte M[MAX_ENTROPY], I[MAX_ENTROPY],
S[MAX_ENTROPY];
if(validate_purpose(drbg->t, p)) { return ERROR;
}
if((r<1)||(r>drbg->width)) { return ERROR;
}
m = ceil(length/r);
for(l=0:l<m;l++) {

if(aes_ecb(M, drbg->V⊕ drbg->C, drbg->K, drbg->klength,

drbg->width)){ return ERROR; }

dt = get_datetime( );
I = dt + uⱼ + i + M(mod 2^{drbg->,width}).
if(aes_ecb(S, drbg->V⊕I, drbg->K, drbg->klength,

drbg->width)) { return ERROR; }

if(aes_ecb(drbg->V,drbg->V⊕M,drbg->K,drbg->klkength,

drbg->width)) { return ERROR; }

output +|= leftmost r-bits of S; // +| meant to symbolize

concatenate current fill

drbg->i = drbg->i + 1;

}
return SUCCESS;

}

TABLE 2

| | | |
|---|---|---|
| #define | SUCCESS | 0 |
| #define | ERROR | 0xFFFFFFFF |
| #define | MIN_ENTROPY_RATE | 8 |
| #define | MAX_ENTROPY | 512 |
| #define | MAX_SEED_LENGTH | MAX_ENTROPY* |
| | | MAX_ENTROPY_RATE |
| #define | SHA160_SECURITY | 80 |
| #define | SHA224_SECURITY | 112 |
| #define | SHA256_SECURITY | 128 |
| #define | SHA384_SECURITY | 192 |
| #define | SHA512_SECURITY | 256 |
| #define | SHA160_DIGESTSIZE | SHA160_SECURITY*2 |
| #define | SHA224_DIGESTSIZE | SHA224_SECURITY*2 |
| #define | SHA256_DIGESTSIZE | SHA256_SECURITY*2 |
| #define | SHA384_DIGESTSIZE | SHA384_SECURITY*2 |
| #define | SHA512_DIGESTSIZE | SHA512_SECURITY*2 |

typedef struct _cb_drbg{

int k;
int width;
byte *V;
byte *i
byte *C;
byte *t;

}cb_drbg;
int hash(byte *out, byte *in, int HASH);
int entropy(byte *out, int *outlen, int k);
int validate_purpose(byte *t1, byte *t2);
int validate_new_drbg(cb_drbg *new, cb_drbg *old);
int initialize(cb_drbg *drbg, int k, byte *t){

byte seed[MAX_SEED_LENGTH];
int slength = MAX_SEED_LENGTH;
if((k!=SHAXXX_SECURITY)) { return ERROR; }
drbg->width = SHAXXX_DIGESTSIZE;
drbg->k = k;
if(entropy(seed, &slength, drbg->width)) { return ERROR; }
if(validate_purpose(t, NULL)) { return ERROR; }
drbg->t = t;
drbg->i = 1;
if(hash(drbg->V, seed, drbg->k)) { return ERROR; }
if(hash(drbg->C, seed | drbg->V, drbg->k)) { return ERROR; }
return SUCCESS;

}
int reseed(cb_drbg *drbg, int k, byte *t){

byte seed[MAX_SEED_LENGTH];
int slength = MAX_SEED_LENGTH;
cb_drbg olddrbg;
olddrbg = drbg;
if(k!=drbg->k) { return ERROR;
}
if(validate_purpose(drbg->t, t)) { return ERROR;
}
if(entropy(seed, &slength, drbg->width)) { return ERROR;
}
if(hash(drbg->V, seed|drbg->V|drbg->i|drbg->C, drbg->k))
{ return ERROR;
}
if(hash(drbg->C, seed | drbg->V, drbg->k)) { return ERROR; }
drbg->i = 1;
if(validate_new_drbg(drbg, olddrbg)) { return ERROR;
}
destroy(olddrbg);
return SUCCESS;

}
int generate(byte *output, int length, cb_drbg *drbg, byte *user, int
ulength, int r,
byte *p){

int l, m;
byte V[SHA512_DIGESTSIZE/8], X[SHA512_DIGESTSIZE/8];
if(validate_purpose(drbg->t, p)) { return ERROR;
}
if((r<1)||(r>drbg->width)) { return ERROR;
}
m = ceil(length/r);
if(hash(V, user|drbg->C|drbg->V, drbg->k)) { return ERROR;
}
for(l=0:l<m;l++){

if(hash(X, V, drbg->k)) { return ERROR;

}

output +| = leftmost r-bits of X; // +| meant to symbolize

concatenate current fill

V = V + 1 (mod 2^{drbg->width})

}
output = leftmost length-bits of output;
drbg->V = hash(V + output + drbg->i mod 2^{drbg->width},);
drbg->i = drbg->i + 1;
return SUCCESS;

}

TABLE 3

| | | |
|---|---|---|
| #define | SUCCESS | 0 |
| #define | ERROR | 0xFFFFFFFF |
| #define | MIN_ENTROPY_RATE | 8 |
| #define | MAX_ENTROPY | 512 |
| #define | MAX_SEED_LENGTH | MAX_ENTROPY* |
| | | MAX_ENTROPY_RATE |
| #define | SHA160_SECURITY | 80 |
| #define | SHA224_SECURITY | 112 |
| #define | SHA256_SECURITY | 128 |
| #define | SHA384_SECURITY | 192 |
| #define | SHA512_SECURITY | 256 |
| #define | SHA160_DIGESTSIZE | SHA160_SECURITY*2 |
| #define | SHA224_DIGESTSIZE | SHA224_SECURITY*2 |
| #define | SHA256_DIGESTSIZE | SHA256_SECURITY*2 |
| #define | SHA384_DIGESTSIZE | SHA384_SECURITY*2 |
| #define | SHA512_DIGESTSIZE | SHA512_SECURITY*2 |

typedef struct _cb_drbg{

int k;
int width;
byte *V;
byte *i
byte *C;
byte *K;
byte *t;

}cb_drbg;
int hash(byte *out, byte *in, int HASH);
int khash(byte *out, byte *in, byte *key, int HASH);
int entropy(byte *out, int *outlen, int k);
int validate_purpose(byte *t1, byte *t2);
int validate_new_drbg(cb_drbg *new, cb_drbg *old);
int initialize(cb_drbg *drbg, int k, byte *t)
{

byte seed[MAX_SEED_LENGTH];
int slength = MAX_SEED_LENGTH;
if((k!=SHAXXX_SECURITY)) { return ERROR; }
drbg->width = SHAXXX_DIGESTSIZE;
drbg->k = k;
if(entropy(seed, &slength, drbg->width)) { return ERROR; }
if(validate_purpose(t, NULL)) { return ERROR; }
drbg->t = t;
drbg->i = 1;
if(hash(drbg->V, seed, drbg->k)) { return ERROR; }
if(entropy(seed, &slength, drbg->width)) { return ERROR; }
if(hash(drbg->K, seed | drbg->V, drbg->k)) { return ERROR; }
if(khash(drbg->C, drbg->V, drbg->K, drbg->k)) { return ERROR; }
return SUCCESS;

}
int reseed(cb_drbg *drbg, int k, byte *t)
{

byte seed[MAX_SEED_LENGTH];
int slength = MAX_SEED_LENGTH;
cb_drbg olddrbg;
olddrbg = drbg;
if(k!=drbg->k) { return ERROR;
}
if(validate_purpose(drbg->t, t)) { return ERROR;
}
if(entropy(seed, &slength, drbg->width)) { return ERROR;
}
if(hash(drbg->V, seed|drbg->V|drbg->i|drbg->C|drbg->K, drbg->k))
{ return ERROR;
}
if(entropy(seed, &slength, drbg->width)) { return ERROR;
}
if(hash(drbg->K, seed | drbg->V, drbg->k)) { return ERROR;
}
if(khash(drbg->C, drbg->V, drbg->K, drbg->k)) { return ERROR;
}
drbg->i = 1;
if(validate_new_drbg(drbg, olddrbg)) { return ERROR;
}
destroy(olddrbg);
return SUCCESS;

}
int generate(byte *output, int length, cb_drbg *drbg, byte *user, int
ulength, int r,
byte *p)
{

int l, m;
byte V[SHA512_DIGESTSIZE/8], X[SHA512_DIGESTSIZE/8];
if(validate_purpose(drbg->t, p)) { return ERROR;
}
if((r<1)||(r>drbg->width)) { return ERROR;
}
m = ceil(length/r);
if(khash(V, user|drbg->C|drbg->V, drbg->K, drbg->k)) { return

ERROR; }

for(l=0:l<m;l++){

if(khash(X, V, drbg->K, drbg->k)) { return

ERROR; }

output +| = leftmost r-bits of X; // +| meant to symbolize

concatenate current fill

V = V + 1 (mod 2^{drbg->width})

}
output = leftmost length-bits of output;
drbg->V = V + output + drbg->i mod 2^{drbg->width};
drbg->i = drbg->i + 1;
return SUCCESS;

}

The embodiments described above and illustrated in the attached drawings have been given by way of example and illustration only. From the teachings of the present application those skilled in the art will readily recognize numerous other embodiments in accordance with the subject invention. Accordingly, limitations on the subject invention are to be found only in the claims set forth below.

What is claimed is:

1. A method for generating a random bit value utilized for cryptographic security comprising:
inputting a seed from an entropy source;
generating an initial state as a function of said seed, said initial state comprising a plurality of components;
receiving a request to generate a random bit value;
mixing all components of a current state, where said current state is initially said initial state, to generate an output string and a next state;
setting said current state to said next state, whereby said mixing all components of a current state and setting said current state to said next state can be repeated to generate successive output strings; and
deriving said requested random bit value from at least one of said output strings.

2. A method as described in claim 1 where said plurality of components of which said initial state is comprised are generated by mixing said seed with itself or with other information.

3. A method as described in claim 2 where said seed is mixed using a codebook key definition function.

4. A method as described in claim 2 where said seed is mixed using a hash function.

5. A method as described in claim 2 where said seed is mixed using a keyed hash function.

6. A method as described in claim 1 where mixing all components of a current state further comprises:
mixing all components of a current state using a codebook function.

7. A method as described in claim 1 where mixing all components of a current state further comprises:
mixing all said components of a current state using a hash function.

8. A method as described in claim 1 where mixing all components of a current state further comprises:
mixing all said components of a current state using a keyed hash function.

9. A method as described in claim 1 where said output string is specified to be n bits in length and said components of a current state are mixed m times, each time generating a substring r bits in length, where m times r is greater than or equal to n and said output string is chosen to be n predetermined bits of a concatenation of said substrings.

10. A method as described in claim 9 where mixing all components of a current state further comprises:
mixing all components of a current state using a codebook function.

11. A method as described in claim 9 where mixing all components of a current state further comprises:
mixing all said components of a current state using a hash function.

12. A method as described in claim 9 where mixing all components of a current state further comprises:
mixing all said components of a current state using a keyed hash function.

13. A method as described in claim 1 where said random bit value is to be utilized as a cryptographic key, and where an input p is tested to determine if the intended use of said cryptographic key is permitted and, if not permitted, said random bit value is not generated.

14. A method as described in claim 1, where said seed s has k bits of entropy, and generating said initial state further comprises:
determining parameters CB_KEY_LENGTH and CB_WIDTH, each of said parameters being greater than or equal to k;
determining application constants KEY_CONST1, KEY_CONST2, KEY_CONST3, C_CONST, and V_CONST;
setting a codebook key kdk equal to CB_KEY_LENGTH predetermined bits of said seed s;
computing a component K1 as a codebook key derivation function:
cb_kdf(CB_KEY_LENGTH, kdk, s, KEY_CONST1);
computing a component K2 as a codebook key derivation function:
cb_kdf(CB_KEY_LENGTH, kdk, s, KEY_CONST2);
computing a component K3 as a codebook key derivation function:
cb_kdf(CB_KEY_LENGTH, kdk, s, KEY_CONST3);
computing a component V₀ as a codebook key derivation function:
cb_kdf(CB_KEY_LENGTH, kdk, s, V_CONST);
computing a component C as a codebook key derivation function:
cb_kdf(CB_KEY_LENGTH, kdk, s, C_CONST);
setting an index component i equal to 1; and
outputting an initial state S₀ comprising said components V₀, i, C, K1, K2, and K3.

15. A method as described in claim 1, where said seed s has k bits of entropy, and generating said initial state further comprises:
determining a seed s, said seed s having k bits of entropy;
determining parameters CB_KEY_LENGTH and CB_WIDTH, each of said parameters being greater than or equal to k;
determining application constants KEY_CONST1, C_CONST, and V_CONST;
setting a codebook key kdk equal to CB_KEY_LENGTH predetermined bits of said seed s;
computing a component K1 as a codebook key derivation function:
cb_kdf(CB_KEY_LENGTH, kdk, s, KEY_CONST1);
computing a component V₀ as a codebook key derivation function:
cb_kdf(CB_KEY_LENGTH, kdk, s, V_CONST);
computing a component C as a codebook key derivation function:
cb_{—}kdf(CB_KEY_LENGTH, kdk, s, C_CONST);
setting an index component i equal to 1; and
outputting an initial state S₀ comprising said components V₀, i, C, and K1.

16. A method as described in claim 1 where a current state Sⱼ includes components V₀, i, C, K1, K2, and K3, and mixing all components of a current state Sⱼ to generate an output string and a next state Sⱼ₊₁ comprises:
determining said state Sⱼ;
determining a length n for said output string, and a rate r at which said output string will be generated;
setting an integer value m equal to the smallest integer greater than length n divided by rate r, where r is an integer greater than 0 and less than or equal to the length of component C;
setting a variable V equal to said component Vⱼ;
setting an index q equal to 1;
computing a variable M as a codebook function:
M=cb(V xor C, K1), where “xor” represents an exclusive or operation;
determining auxiliary data dt;
computing a variable I as an auxiliary mixing function af having at least the operands dt, i, and M;
computing a variable W as a codebook function W=cb(V xor l, K2);
computing a variable V as a codebook function V=cb(V xor M, K3);
setting a variable R_{q} equal to r predetermined bits of said variable W;
setting said component i equal to i+1, and said index q equal to q+1;
if said index q is not equal to m+1, returning to compute a variable M; otherwise
setting a next component Vⱼ₊₁ equal to said variable V; and
computing said output string as n predetermined bits of a concatenation of variables R_{q}, where q equals 1 to m,
whereby said next state Sⱼ₊₁ is determined as including (Vⱼ₊₁, i, C, K1, K2, K3).

17. A method as described in claim 16 where said components K2 and K3 are equal to said component K1.

18. A method as described in claim 1, where said seed s has 2* k bits of entropy, and generating said initial state further comprises:
computing a component V₀ as hash function hash(s);
computing a component C as hash function hash(s|V₀);
setting an index component i equal to 1; and
outputting an initial state S₀ comprising said components V₀, i, C.

19. A method as described in claim 1 where a current state Sⱼ includes components Vⱼ, i, C, and mixing all components of a current state Sⱼ to generate an output string and a next state Sⱼ₊₁ comprises:
determining said state Sⱼ;
determining a length n for said output string, a rate r at which said output string will be generated, and a parameter HASH_DIGESTSIZE;
setting an integer value m equal to the smallest integer greater than length n divided by rate r, where r is an integer greater than 0 and less than or equal to HASH_DIGESTSIZE+1;
computing a variable V as a hash function having at least operands C and Vⱼ;
setting an integer value m equal to the smallest integer greater than length n divided by rate r, where r is an integer greater than 0 and less than or equal to the length of component C;
setting an index q equal to 1;
computing a variable x as a hash function x=hash(V);
setting a variable w_{q} equal to r predetermined bits of said variable x;
computing said variable V as a function V=V+1(mod 2^{HASH}^{_{—}}^{DIGESTSIZE});
setting said index q equal to q+1;
if said index q is not equal to m+1, returning to compute a variable x; otherwise
computing said output string as n predetermined bits of a concatenation of variables w_{q}, where q equals 1 to m; and
computing a next component Vⱼ₊₁ as a hash function:
Vⱼ₊₁=hash(V+yⱼ+i(mod 2^{HASH}^{_{—}}^{DIGESTSIZE})),
whereby said next state Sⱼ₊₁ is determined as including (Vⱼ₊₁, i, C).

20. A method as described in claim 1 where generating said initial state further comprises:
determining a first seed s1 and a second seed s2, said seeds s1 and s2 having 2* k bits of entropy;
computing a component V₀ as hash function hash(s1);
computing a component key K as hash function hash(s2|V₀);
computing a component C as keyed hash function khash(V₀, K);
setting an index component i equal to 1; and
outputting an initial state S₀ comprising said components V₀, i, C, K.

21. A method as described in claim 1 where a current state Sⱼ includes components Vⱼ, i, C, K and mixing all components of a current state Sⱼ to generate an output string and a next state Sⱼ₊₁ comprises:
determining said state Sⱼ;
determining a length n for said output string, a rate r at which said output string will be generated and a parameter HASH_DIGESTSIZE;
setting an integer value m equal to the smallest integer greater than length n divided by rate r, where r is an integer greater than 0 and less than or equal to HASH_DIGESTSIZE+1;
computing a variable V as a keyed hash function having at least operands C and Vⱼ, and key K;
setting an index q equal to 1;
setting an integer value m equal to the smallest integer greater than length n divided by rate r, where r is an integer greater than 0 and less than or equal to the length of component C;
computing a variable x as a keyed hash function x=khash(V, K);
setting a variable w_{q} equal to r predetermined bits of said variable x;
computing said variable V as a function V=V+1(mod 2^{HASH}^{_{—}}^{DIGESTSIZE})
setting said index q equal to q+1;
if said index q is not equal to m+1, returning to computing a variable x; otherwise
computing said output string as n predetermined bits of a concatenation of variables w_{q}, where q equals 1 to m; and
computing a next component Vⱼ₊₁ as a hash function:
Vⱼ₊₁=hash(V+yⱼ+i(mod 2^{HASH}^{_{—}}^{DIGESTSIZE})),
whereby said next state Sⱼ₊₁ is determined as including (Vⱼ₊₁, i, C, K).

22. A programmable data processing system for generating a cryptographic key, said system being programmed to:
input a seed from an entropy source;
generate an initial composite state as a function of said seed, said initial state comprising a plurality of components;
receive a request to generate a random bit value to be utilized as a cryptographic key;
mix all components of a current state, where said current state is initially said initial state, to generate an output string and a next state;
set said current state to said next state, whereby mixing all components of a current state and setting said current state to said next state can be repeated to generate successive output strings with assurance of forward and backward secrecy; and
derive said requested cryptographic key from at least one of said output strings.

23. A system as described in claim 22 where said system is programmed to generate said plurality of components of which said initial state is comprised by mixing said seed with itself or with other information.

24. A system as described in claim 23 where said system is programmed to mix said seed using a codebook key definition function.

25. A system as described in claim 23 where said system is programmed to mix said seed using a hash function.

26. A system as described in claim 23 where said system is programmed to mix said seed using a keyed hash function.

27. A system as described in claim 22 where said system is programmed to mix said components of a current state using a codebook function.

28. A system as described in claim 22 where said system is programmed to mix said components of a current state using a hash function.

29. A system as described in claim 22 where said system is programmed to mix said components of a current state using a keyed hash function.

30. A system as described in claim 22 where said system is programmed to specify said output string to be n bits in length and to mix said components of a current state m times, each time generating a substring r bits in length, where m times r is greater than or equal to n and said output string is chosen to be n predetermined bits of a concatenation of said substrings.

31. A system as described in claim 22 where said system is programmed to determine if the intended use of said cryptographic key is permitted and, if not permitted, said key is not generated.

32. A system as described in claim 22, where said seed s has k bits of entropy, and said system is programmed to generate said initial state by:
determining parameters CB_KEY_LENGTH and CB_WIDTH, each of said parameters being greater than or equal to k;
determining application constants KEY_CONST1, KEY_CONST2, KEY_CONST3, C_CONST, and V_CONST;
setting a codebook key kdk equal to CB_KEY_LENGTH predetermined bits of said seed s;
computing a component K1 as a codebook key derivation function:
cb_kdf(CB_KEY_LENGTH, kdk, s, KEY_CONST1);
computing a component K2 as a codebook key derivation function:
cb_kdf(CB_KEY_LENGTH, kdk, s, KEY_CONST2);
computing a component K3 as a codebook key derivation function:
cb_kdf(CB_KEY_LENGTH, kdk, s, KEY_CONST3);
computing a component V₀ as a codebook key derivation function:
cb_kdf(CB_KEY_LENGTH, kdk, s, V_CONST);
computing a component C as a codebook key derivation function:
cb_kdf(CB_KEY_LENGTH, kdk, s, C_CONST);
setting an index component i equal to 1; and
outputting an initial state So comprising said components V₀, i, C, K1, K2, and K3.

33. A system as described in claim 22 where a current state Sⱼ includes components V₀, i, C, K1, K2, and K3 and said system is programmed to mix all components of a current state Sⱼ to generate an output string and a next state Sⱼ₊₁ by:
determining said state Sⱼ;
determining a length n for said output string, and a rate r at which said output string will be generated;
setting an integer value m equal to the smallest integer greater than length n divided by rate r, where r is an integer greater than 0 and less than or equal to the length of component C;
setting a variable V equal to said component Vⱼ;
setting an index q equal to 1;
computing a variable M as a codebook function M=cb(V xor C, K1), where “xor” represents an exclusive or operation;
determining auxiliary data dt;
computing a variable I as an auxiliary mixing function af having at least the operands dt, i, and M;
computing a variable W as a codebook function W=cb(Vxorl, K2);
computing a variable V as a codebook function V=cb(VxorM, K3);
setting a variable R_{q} equal to r predetermined bits of said variable W;
setting said component i equal to i+1, and said index q equal to q+1;
if said index q is not equal to m+1, returning to compute a variable M ; otherwise
setting a next component Vⱼ₊₁ equal to said variable V; and
computing said output string as n predetermined bits of a concatenation of variables R_{q}, where q equals 1 to m;
whereby said next state Sⱼ₊₁ is determined as including (Vⱼ₊₁, i, C, K1, K2, K3).

34. A system as described in claim 22, where said seed s has 2* k bits of entropy, and said system is programmed to generate said initial state by:
computing a component V₀ as hash function hash(s);
computing a component C as hash function hash(s|V₀);
setting an index component i equal to 1; and
outputting an initial state S₀ comprising said components V₀, i, C.

35. A system as described in claim 22 where a current state Sⱼ includes components Vⱼ, i, C and said system is programmed to mix all components of a current state Sⱼ to generate an output string and a next state Sⱼ₊₁ by:
determining said state Sⱼ;
determining a length n for said output string, a rate r at which said output string will be generated and a parameter HASH_DIGESTSIZE;
setting an integer value m equal to the smallest integer greater than length n divided by rate r, where r is an integer greater than 0 and less than or equal to HASH_DIGESTSIZE+1;
computing a variable V as a hash function having at least operands C and Vⱼ;
setting an integer value m equal to the smallest integer greater than length n divided by rate r, where r is an integer greater than 0 and less than or equal to the length of component C;
setting an index q equal to 1;
computing a variable x as a hash function x=hash(V);
setting a variable w_{q} equal to r predetermined bits of said variable x;
compute said variable V as a function V=V+1(mod 2^{HASH}^{_{—}}^{DIGESTSIZE});
setting said index q equal to q+1;
if said index q is not equal to m+1, returning to compute a variable x; otherwise
computing said output string as n predetermined bits of a concatenation of variables w_{q}, where q equals 1 to m; and
computing a next component Vⱼ₊₁ as a hash function:
Vⱼ₊₁=hash(V+yⱼ+i(mod 2^{HASH}^{_{—}}^{DIGESTSIZE}));
whereby said next state Sⱼ₊₁ is determined as including (Vⱼ₊₁, i, C).

36. A system as described in claim 22 where said system is programmed to generate said initial state by:
determining a first seed s1 and a second seed s2, said seeds s1 and s2 having 2* k bits of entropy;
computing a component V₀ as hash function hash(s1);
computing a component key K as hash function hash(s2|V₀);
computing a component C as keyed hash function khash(V₀, K);
setting an index component i equal to 1; and
outputting an initial state S₀ comprising said components V₀, i, C, K.

37. A system as described in claim 22 where a current state Sⱼ includes components Vⱼ, i, C, K and said system is programmed to mix all components of a current state Sⱼ to generate an output string and a next state Sⱼ₊₁ by:
determining said state Sⱼ;
determining a length n for said output string, a rate r at which said output string will be generated and a parameter HASH_DIGESTSIZE;
setting an integer value m equal to the smallest integer greater than length n divided by rate r, where r is an integer greater than 0 and less than or equal to HASH_DIGESTSIZE+1;
computing a variable V as a keyed hash function having at least operands C and Vⱼ, and key K;
setting an index q equal to 1;
setting an integer value m equal to the smallest integer greater than length n divided by rate r, where r is an integer greater than 0 and less than or equal to the length of component C;
computing a variable x as a keyed hash function x=khash(V, K);
setting a variable w_{q} equal to r predetermined bits of said variable x;
compute said variable V as a function V=V+1(mod 2^{HASH}^{_{—}}^{DIGESTSIZE});
setting said index q equal to q+1;
if said index q is not equal to m+1, returning to computing a variable x; otherwise
computing said output string as n predetermined bits of a concatenation of variables w_{q}, where q equals 1 to m; and
computing a next component Vⱼ₊₁ as a hash function:
Vⱼ₊₁=hash(V+yⱼ+i(mod 2^{HASH}^{_{—}}^{DIGESTSIZE}));
whereby said next state Sⱼ₊₁ is determined as including (Vⱼ₊₁, i, C, K).

38. An encryption system comprising:
an encryption engine for receiving a clear text message and for combining said clear text message with an encryption key to generate an encryption;
a decryption engine for receiving said encryption and for combining said encryption with a decryption key to recover said clear text message;
a key generation system for generating new keys, said key generation system including an entropy source and a data processing system programmed to:
input a seed from said entropy source;
generate an initial composite state as a function of said seed, said initial state comprising a plurality of components;
receive a request to generate a cryptographic key;
mix all components of a current state, where said current state is initially said initial state, to generate an output string of predetermined length and a next state;
set said current state to said next state, whereby mixing al components and setting said current state to said next state can be repeated to generate successive output strings with assurance of forward and backward secrecy; and
derive said requested cryptographic key from at least one of said output strings; and
a secure communications link for distributing said new keys to said encryption engine and said decryption engine.

39. An encryption system as described in claim 38 where said encryption engine is part of a postage meter.
